(19) United States
(12) Patent Application Publication
(10) Pub. No.: US 2006/0011531 A1
(43) Pub. Date: Jan. 19, 2006

(54) Garbage treatment apparatus

(76) Inventor: Sam Jun Bae, Seoul (KR)

Correspondence Address: ST. ONGE STEWARD JOHNSTON & REENS, LLC, 986 BEDFORD STREET, STAMFORD, CT, 06905-5619, US

(21) Appl. No.: 10/892,964

(22) Filed: Jul. 16, 2004

(51) Int. Cl. C02F 3/00

(52) U.S. Cl. 210/194; 210/219

(57) ABSTRACT

A garbage treatment apparatus. A treatment bath is placed in the housing. A perforated plate is installed at a lower end of the treatment bath. An agitator is installed inside the treatment bath to agitate garbage. A drain bath is joined to the lower end of the treatment bath, and formed adjacent to an upper end thereof with a drain opening. This drain opening allows a liquefied garbage part completely decomposed in the treatment bath and introduced through the perforated plate into the drain bath, to be discharged to the outside. A water supplying section periodically supplies water into the treatment and drain baths. A circulating section circulates particulate garbage constituents introduced through the perforated plate into the drain bath and water, into the treatment bath. A heating unit is disposed. A controlling unit is provided to control entire operations of the apparatus.

### FIELD OF THE INVENTION

The present invention relates to a garbage treatment apparatus, and more particularly to a garbage treatment apparatus which circulates and re-treats particulate garbage constituents contained and remaining un-decomposed in garbage primarily treated in a treatment bath, thereby maximizing garbage treatment efficiency.

### DESCRIPTION OF THE PRIOR ART

As generally known in the art, in the conventional garbage treatment apparatus, garbage is fermented and decomposed by microorganisms fed into a treatment bath while the garbage is agitated by an agitator in the treatment bath. Then, the garbage is introduced into a drain bath after passing through a perforated plate which is installed at a lower end of the treatment bath. At this time, the garbage is divided into a liquefied part which is produced by complete decomposition of the garbage, and particulate garbage constituents which are not decomposed. Accordingly, the conventional garbage treatment apparatus encounters a problem in that, since both of the liquefied part and the particulate garbage constituents are discharged to the outside through a drain opening of the drain bath, offensive odor is produced by the particulate garbage constituents to provoke environmental pollution.

Also, in the conventional garbage treatment apparatus, because water supplied into the treatment bath by water supplying means flows into the drain bath through the perforated plate by its own weight and immediately drained to the outside, a certain amount of water must be continuously supplied into the treatment bath to insure that the treatment bath is always filled with water. Thus, it is difficult to reduce water consumption, and cost effectiveness of the garbage treatment apparatus is deteriorated.

Further, in the conventional garbage treatment apparatus, due to the fact that the microorganisms are periodically fed by manual work into the treatment bath to ferment and decompose garbage while the garbage is poured into the treatment bath, it is inconvenient and cumbersome to feed the microorganisms into the treatment bath.

Moreover, in the conventional garbage treatment apparatus, since agitating blades provided to the agitator are fastened to an agitating shaft by means of welding, a welding operation becomes troublesome, and the agitating shaft is likely to be deformed due to heat generated upon performing the welding operation.

Furthermore, as a paddle secured to a distal end of each agitating blade is brought into contact with the perforated plate installed at the lower end of the treatment bath while the agitator performs an agitating operation, the likelihood of the perforated plate to be damaged is increased.

In addition, the conventional garbage treatment apparatus suffers from defects in that, because a treatment bath nozzle pipe serving as the water supplying means for supplying water into the treatment bath is formed in such a way as to extend into the treatment bath, the treatment bath nozzle pipe interferes with the agitating blades of the agitator, whereby breakage of the treatment bath nozzle pipe may be caused.

### SUMMARY OF THE INVENTION

Accordingly, the present invention has been made to solve the above-mentioned problems occurring in the prior art, and an object of the present invention is to provide a garbage treatment apparatus which is constructed to discharge a liquefied part of garbage, produced by fermentation and decomposition through primary treatment in a treatment bath, and circulate and re-treat un-decomposed particulate garbage constituents so that only completely decomposed liquefied part of the garbage can be discharged to the outside, thereby improving garbage treatment efficiency.

Another object of the present invention is to provide a garbage treatment apparatus which circulates water supplied into the treatment bath and discharged through a drain bath, into the treatment bath so that the water can be reused, thereby reducing water consumption and ameliorating cost effectiveness of the garbage treatment apparatus.

Another object of the present invention is to provide a garbage treatment apparatus which is constructed to allow microorganisms to be automatically fed into the treatment bath along with water supplied, thereby eliminating inconvenience and cumbersomeness which can be otherwise caused by a manual feeding operation of the microorganisms.

Another object of the present invention is to provide a garbage treatment apparatus in which agitating blades to be coupled with an agitating shaft of an agitator are partially shaped in the form of bolts to be locked with nuts, thereby improving assemblability of the apparatus and preventing the agitating shaft from being deformed.

Still another object of the present invention is to provide a garbage treatment apparatus in which a cover element made of urethane is fixed to a paddle provided to a distal end of each agitating blade constituting the agitator, thereby preventing a perforated plate from being damaged in the treatment bath while the agitator performs an agitating operation.

Yet still another object of the present invention is to provide a garbage treatment apparatus in which a treatment bath nozzle pipe for supplying water into the treatment bath is formed to be positioned above a housing, thereby preventing the treatment bath nozzle pipe from being broken by the agitating blades of the agitator.

In order to accomplish the above objects, there is provided a garbage treatment apparatus comprising: a housing defining an outer appearance of the apparatus; a treatment bath placed in the housing, formed at an upper end thereof with a garbage inlet, and having installed at a lower end thereof a perforated plate; an agitator installed inside the treatment bath to agitate garbage poured through the garbage inlet into the treatment bath; agitating means for rotating the agitator; a drain bath joined to the lower end of the treatment bath, and formed adjacent to an upper end thereof with a drain opening for allowing a liquefied garbage part completely decomposed in the treatment bath and introduced through the perforated plate into the drain bath to be discharged to the outside; water supplying means for periodically supplying water into the treatment and drain baths to ensure that the treatment bath is filled with water and the drain bath is kept clean; circulating means for circulating particulate garbage constituents introduced through the perforated plate into the drain bath and water into the treatment bath; heating means installed outside the treatment bath to keep a temperature in the treatment bath constant; and controlling means connected to the agitating means, water supplying means, circulating means and heating means to control entire operations of the apparatus for treatment of the garbage.

According to another aspect of the present invention, a microorganism-feeding trough, in which microorganisms to be fed into the treatment bath along with water supplied by the water supplying means are received and which is defined through a bottom wall thereof with a plurality of microorganism-feeding apertures, is provided at the upper end of the treatment bath.

According to another aspect of the present invention, the agitator comprises an agitating shaft and a plurality of agitating blades each of which is fastened to the agitating shaft to extend in a radial direction and has secured to a distal end thereof a paddle, each agitating blade being locked by a nut after passing through a hole defined through the agitating shaft.

According to another aspect of the present invention, a cover element made of urethane is fixed by bolts to a surface of the paddle secured to each agitating blade.

According to another aspect of the present invention, the agitating means comprises a motor, and a belt which operatively connects a driving pulley of the motor and a driven pulley of the agitator with each other for transferring rotation force of the motor.

According to another aspect of the present invention, the water supplying means comprises a pair of small-diameter water supplying pipes which are branched from a large-diameter water supplying pipe connected to a main service pipe, a pair of solenoid valves which are respectively installed in the middle of the small-diameter water supplying pipes and connected to the controlling means to open and close the small-diameter water supplying pipes, a treatment bath nozzle pipe which is connected to one of the small-diameter water supplying pipes to extend beyond the upper end of the treatment bath, and a drain bath nozzle pipe which is connected to the other of the small-diameter water supplying pipes to extend beyond the upper end of the drain bath.

According to another aspect of the present invention, the treatment bath nozzle pipe extends beyond an upper end of the housing to a height where the treatment bath nozzle pipe does not interfere with the agitator installed inside the treatment bath.

According to still another aspect of the present invention, the circulating means comprises water re-supplying nozzle pipe which has one end communicated with the inside of the drain bath through a bottom wall of the drain bath and the other end extending to the upper end of the treatment bath, and a pump which is installed on the water re-supplying nozzle pipe to pump water and the particulate garbage constituents accumulated on the bottom wall of the drain bath toward the treatment bath.

According to yet still another aspect of the present invention, the controlling means conducts its controlling task so that the operation of the water supplying means is interrupted while the circulating means is operated.

### BRIEF DESCRIPTION OF DRAWINGS

The above and other objects, features and advantages of the present invention will be more apparent from the following detailed description when taken in conjunction with the accompanying drawings, in which:

FIG. 1 is a cross-sectional view illustrating a construction of a garbage treatment apparatus in accordance with an embodiment of the present invention;

FIG. 2 is a schematic perspective view illustrating a state wherein a microorganism-feeding trough is installed on the garbage treatment apparatus according to the present invention;

FIG. 3 is an enlarged view of an agitating blade according to the present invention;

FIG. 4 is a partial enlarged view of a treatment bath nozzle pipe according to the present invention.

### DETAILED DESCRIPTION OF PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

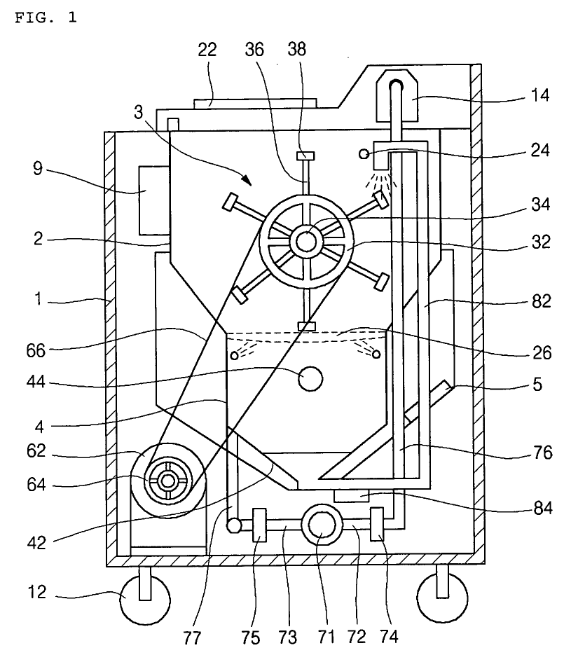

FIG. 1 is a cross-sectional view illustrating a construction of a garbage treatment apparatus in accordance with an embodiment of the present invention. In the garbage treatment apparatus, a treatment bath 2, an agitator 3, a drain bath 4, heating means 5, agitating means, water supplying means, water re-supplying means, a control unit 9 serving as controlling means, and so forth, are placed in a housing 1 which has a predetermined configuration.

Several casters 12 are rotatably mounted to a lower surface of the housing 1.

The treatment bath 2 is positioned in an upper half of the housing 1, and the agitator 3 is installed inside the treatment bath 2. The drain bath 4 is connected to a lower end of the treatment bath 2 so that they are communicated with each other.

A closure member 22 is installed at an upper end of the treatment bath 2 to be opened and closed as occasion demands so that garbage can be poured into the treatment bath 2. A gas outlet 24 is defined through a side wall of the treatment bath 2 adjacent to the upper end of the treatment bath 2, so that gas produced in the treatment bath 2 can be discharged to the outside through the gas outlet 24. A sensor is installed on the closure member 22 so that, when the closure member 22 is opened, the control unit 9 is signaled to interrupt the operation of the agitating means.

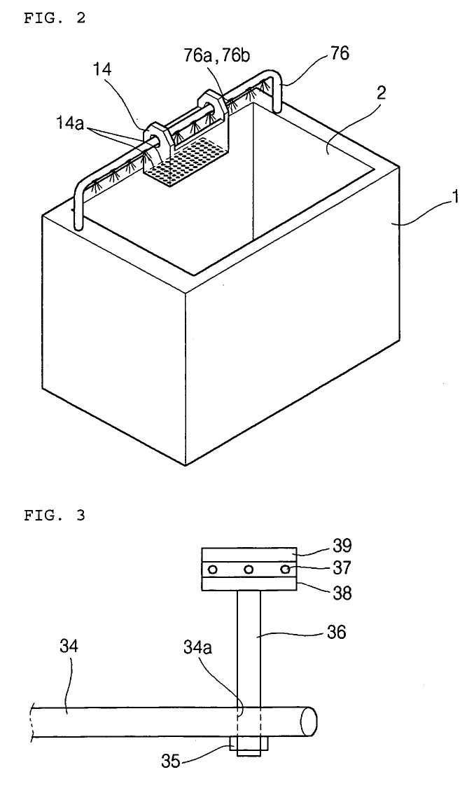

At the upper end of the treatment bath 2, a microorganism-feeding trough 14 is installed to be received in the treatment bath 2 directly below the closure member 22. A perforated plate 26 having a plurality of perforations is installed at the lower end of the treatment bath 2. As can be readily seen from FIG. 2, the microorganism-feeding trough 14 is installed to be suspended from a treatment bath nozzle pipe 76. Accordingly, water can be injected into the microorganism-feeding trough 14 through a plurality of injection nozzles 76a and 76b which are defined in the treatment bath nozzle pipe 76. A plurality of microorganism-feeding apertures 14a for allowing microorganisms to be fed into the treatment bath 2 which is placed in the housing 1, are defined through a bottom wall of the microorganism-feeding trough 14.

The agitator 3 comprises an agitating shaft 34 which is installed at a center portion of a pulley 32, and a plurality of agitating blades 36 each of which is fastened to the agitating shaft 34 to extend in a radial direction and has secured to a distal end thereof a paddle 38. As best shown in FIG. 3, the agitating shaft 34 is defined with holes 34a, so that each agitating blade 36 is inserted through each hole 34a and locked to the agitating shaft 34 by a nut 35. Also, a cover element 39 made of urethane is fixed by bolts 37 to a surface of the paddle 38 which is secured to each agitating blade 36.

The drain bath 4 has an inclined surface 42 which is formed so that a sectional area of the drain bath 4 is gradually decreased from a middle portion toward a lower end of the drain bath 4. A drain opening 44 is defined adjacent to an upper end of the drain bath 4.

As the heating means, a heater 5 is arranged at a side of the lower end of the drain bath 4.

The agitating means comprises a motor 62, and a belt 66 which operatively connects a driving pulley 64 of the motor 62 and a driven pulley 32 of the agitator 3 with each other, for transferring rotation force of the motor 62 to the agitator 3.

In the water supplying means, a pair of small-diameter water supplying pipes 72 and 73 are branched from a large-diameter water supplying pipe 71 which is connected to a main service pipe, and a pair of solenoid valves 74 and 75 for opening and closing the small-diameter water supplying pipes 72 and 73 are installed in the middle of the small-diameter water supplying pipes 72 and 73, respectively. The solenoid valves 74 and 75 are connected to the control unit 9 to be controlled thereby in their operations. The small-diameter water supplying pipe 72 is connected to the treatment bath nozzle pipe 76 which extends beyond the upper end of the treatment bath 2, to supply water into the treatment bath 2, and the small-diameter water supplying pipe 73 is connected to a drain bath nozzle pipe 77 which extends beyond the upper end of the drain bath 4, to supply water into the drain bath 4. At this time, the treatment bath nozzle pipe 76 extends to a height where the treatment bath nozzle pipe 76 does not interfere with the agitator 3 installed inside the treatment bath 2.

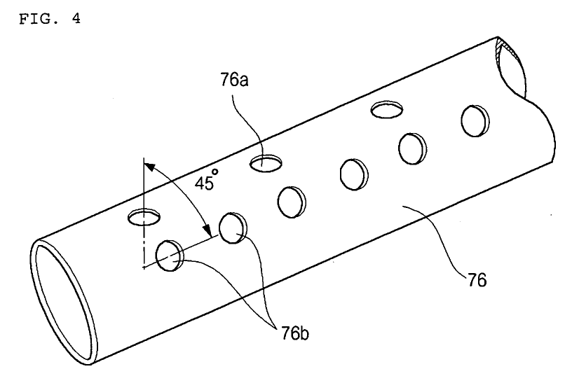

As shown in FIG. 4, the treatment bath nozzle pipe 76 is defined with the plurality of injection nozzles 76a and 76b. These first and second injection nozzles 76a and 76b are formed such that an angle of 45° is defined between them and their numbers have a ratio of 1:2.

The circulating means comprises water re-supplying nozzle pipe 82 which is installed to be communicated with the inside of the drain bath 4 through a bottom wall of the drain bath 4 and injects water at a position of the upper end of the treatment bath 2, and a pump 84 which is installed on the water re-supplying nozzle pipe 82 to pump water from the drain bath 4.

Hereafter, a garbage treatment procedure which is implemented by the garbage treatment apparatus according to the present invention, constructed as mentioned above, will be described.

After opening the closure member 22, pouring garbage into the treatment bath 2 and closing the closure member 22, the agitator 3 installed inside the treatment bath 2 is rotated with an interval of 10˜15 minutes at a speed of 5˜6 rpm for 3 minutes by rotation force of the motor 3, to mix the microorganisms and the garbage with each other.

At the same time, water is supplied by way of the water supplying pipes 71 and 72 and through the treatment bath nozzle pipe 76 into the treatment bath 2. At this time, a portion of water which is injected from the treatment bath nozzle pipe 76 enters the microorganism-feeding trough 14, and forces the microorganisms residing in the microorganism-feeding trough 14 to be fed along with water into the treatment bath 2 through the microorganism-feeding apertures 14a of the microorganism-feeding trough 14.

Due to the fact that the treatment bath nozzle pipe 76 is installed above the housing 1, it is possible to prevent the treatment bath nozzle pipe 76 from interfering with the agitating blades 36 of the agitator 3, which are rotated in the treatment bath 2.

The heater 5 arranged in the housing 1 functions to keep a temperature in the treatment bath 2 constant so that growth of the microorganisms is optimized. As a temperature around the heater 5 rises, a temperature of the treatment bath nozzle pipe 76 which passes by the heater 5 is also increased, and thereby, a temperature of water flowing through the treatment bath nozzle pipe 76 is increased.

Due to establishment of the optimized growth condition, as the agitator 3 is rotated in the treatment bath 2, the microorganisms act to ferment and decompose the garbage. At this time, the paddle 38 is secured to the distal end of each agitating blade 36 which is fastened to the agitating shaft 34 of the agitator 3, and the cover element 39 made of urethane is fixed to the surface of the paddle 38, whereby the perforated plate 26 installed at the lower end of the treatment bath 2 is prevented from being damaged.

Gas produced in the treatment bath 2 while the garbage is fermented and decomposed is discharged to the outside through the gas outlet 24. A liquefied garbage part completely decomposed in the treatment bath 2 and particulate garbage constituents incompletely decomposed in the treatment bath 2 are introduced through the perforated plate 26 into the drain bath 4 while flowing downward along with water.

Since the drain opening 44 is defined adjacent to the upper end of the drain bath 4, the liquefied garbage part and the particulate garbage constituents introduced into the drain bath 4 in this way are not directly discharged through the drain opening 44, and instead, accommodated in the drain bath 4. At this time, the liquefied garbage part completely decomposed is held mixed with water, and the particulate garbage constituents incompletely decomposed immerse on the bottom wall of the drain bath 4 due to a difference in specific weight. Consequently, with the lapse of time, the liquefied garbage part completely decomposed is discharged along with water through the drain opening 44 defined adjacent to the upper end of the drain bath 4, and the particulate garbage constituents incompletely decomposed are accumulated on the bottom wall of the drain bath 4.

In this state, as the pump 84 of the circulating means is actuated, the particulate garbage constituents accumulated on the bottom wall of the drain bath 4 are circulated along with water into the treatment bath 2 through the water re-supplying nozzle pipe 82 which is connected to the lower end of the drain bath 4. In this case where water accommodated in the drain bath 4 is supplied into the treatment bath 2, the operation of the water supplying means is interrupted under the control by the control unit 9. Hence, the particulate garbage constituents incompletely decomposed are supplied along with water into the treatment bath 2 by the circulating means and then secondarily agitated by the agitator 3 to be fermented and decomposed again. By the fact that water primarily supplied into the treatment bath 2 is secondarily supplied from the drain bath 4 into the treatment bath 2, it is possible to supply water while obviating the need of continuously operating the water supplying means.

In this way, because the particulate garbage constituents incompletely decomposed are repeatedly circulated into the treatment bath 2 by the circulating means, garbage can be discharged through the drain opening 44 of the drain bath 4 to the outside only when being completely decomposed.

As apparent from the above description, the garbage treatment apparatus according to the present invention provides advantages as described below.

First, in the present invention, since particulate garbage constituents, which are contained and remaining un-decomposed in garbage primarily treated in a treatment bath and then introduced into a drain bath, are circulated into and re-treated in the treatment bath so that the garbage can be completely decomposed, it is possible to eliminate subsequent processing operations for collecting and burying or burning the un-decomposed particulate garbage constituents, which is otherwise needed in the conventional art.

Second, in the present invention, due to the fact that water flowing from the treatment bath into the drain bath is circulated into the treatment bath along with the particulate garbage constituents introduced into the drain bath in an un-decomposed state, to be reused, it is not necessary to continuously supply water into the treatment bath using water supplying means, whereby water consumption can be significantly reduced and cost effectiveness of the apparatus can be ameliorated.

Third, in the present invention, because a microorganism-feeding trough is installed on a treatment bath nozzle pipe provided to the treatment bath, microorganisms are automatically fed into the treatment bath along with water, whereby inconvenience and cumbersomeness which can be otherwise caused by a manual feeding operation of the microorganisms in the conventional art are eliminated.

Fourth, in the present invention, since agitating blades to be coupled with an agitating shaft of an agitator are partially shaped in the form of bolts to be locked with nuts, assemblability of the apparatus is improved, deformation of the agitating shaft is prevented, and replacement of the agitating blades can be easily implemented.

Fifth, in the present invention, due to the fact that a cover element made of urethane is fixed to a paddle provided to a distal end of each agitating blade, a perforated plate is prevented from being damaged while the agitator is rotated.

Sixth, in the present invention, because the treatment bath nozzle pipe for supplying water into the treatment bath is formed to be positioned above a housing, the treatment bath nozzle pipe is prevented from being broken by interference with the agitating blades of the agitator.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A garbage treatment apparatus comprising:
a housing defining an outer appearance of the apparatus;
a treatment bath placed in the housing, formed at an upper end thereof with a garbage inlet, and having installed at a lower end thereof a perforated plate;
an agitator installed inside the treatment bath to agitate garbage poured through the garbage inlet into the treatment bath;
agitating means for rotating the agitator;
a drain bath joined to the lower end of the treatment bath, and formed adjacent to an upper end thereof with a drain opening for allowing a liquefied garbage part completely decomposed in the treatment bath and introduced through the perforated plate into the drain bath to be discharged to the outside;
water supplying means for periodically supplying water into the treatment and drain baths to ensure that the treatment bath is filled with water and the drain bath is kept clean;
circulating means for circulating particulate garbage constituents introduced through the perforated plate into the drain bath and water into the treatment bath;
heating means installed outside the treatment bath to keep a temperature in the treatment bath constant; and
controlling means connected to the agitating means, water supplying means, circulating means and heating means to control entire operations of the apparatus for treatment of the garbage.

2. The apparatus as claimed in claim 1, wherein a microorganism-feeding trough, in which microorganisms to be fed into the treatment bath along with water supplied by the water supplying means are received and which is defined through a bottom wall thereof with a plurality of microorganism-feeding apertures, is provided at the upper end of the treatment bath.

3. The apparatus as claimed in claim 1, wherein the agitator comprises an agitating shaft and a plurality of agitating blades each of which is fastened to the agitating shaft to extend in a radial direction and has secured to a distal end thereof a paddle, each agitating blade being locked by a nut after passing through a hole defined through the agitating shaft.

4. The apparatus as claimed in claim 3, wherein a cover element made of urethane is fixed by bolts to a surface of the paddle secured to each agitating blade.

5. The apparatus as claimed in claim 1, wherein the agitating means comprises a motor, and a belt which operatively connects a driving pulley of the motor and a driven pulley of the agitator with each other for transferring rotation force of the motor.

6. The apparatus as claimed in claim 1, wherein the water supplying means comprises a pair of smaller-diameter water supplying pipes which are branched from a larger-diameter water supplying pipe connected to a main service pipe, a pair of solenoid valves which are respectively installed in the middle of the smaller-diameter water supplying pipes and connected to the controlling means to open and close the smaller-diameter water supplying pipes, a treatment bath nozzle pipe which is connected to one of the smaller-diameter water supplying pipes to extend beyond the upper end of the treatment bath, and a drain bath nozzle pipe which is connected to the other of the smaller-diameter water supplying pipes to extend beyond the upper end of the drain bath.

7. The apparatus as claimed in claim 6, wherein the treatment bath nozzle pipe extends beyond an upper end of the housing to a height where the treatment bath nozzle pipe does not interfere with the agitator installed inside the treatment bath.

8. The apparatus as claimed in claim 1, wherein the circulating means comprises water re-supplying nozzle pipe which has one end communicated with the inside of the drain bath through a bottom wall of the drain bath and the other end extending to the upper end of the treatment bath, and a pump which is installed on the water re-supplying nozzle pipe to pump water and the particulate garbage constituents accumulated on the bottom wall of the drain bath toward the treatment bath.

9. The apparatus as claimed in claim 1, wherein the controlling means conducts its controlling task so that the operation of the water supplying means is interrupted while the circulating means is operated.

10. A garbage treatment apparatus comprising:
a housing defining an outer appearance of the apparatus and having a garbage inlet;
a treatment bath disposed in the housing and having a perforated plate installed at a lower end thereof;
an agitator installed inside the treatment bath and coupled with an actuator for agitating garbage poured through the garbage inlet into the treatment bath;
a drain bath disposed at the lower end of the treatment bath for receiving a decomposed garbage through the perforated plate, the drain bath having a drain opening adjacent to an upper end thereof for allowing the decomposed garbage in the drain bath to be discharged to the outside;
a water supply pipe for supplying water into the treatment and drain baths;
a re-supply pipe extending between a lower portion of the drain bath and an upper portion of the treatment bath for resupplying particulate garbage constituents back to the treatment bath for further treatment;
a heater installed within the housing for controlling a temperature in the treatment bath in a condition for facilitating growth of microorganisms in the treatment bath; and
a controller coupled with the actuator and the heater for controlling operation of the garbage treatment apparatus.

11. The apparatus as claimed in claim 10, wherein a microorganism-feeding trough is provided at the upper end of the treatment bath, the microorganism-feeding trough having a plurality of microorganism-feeding apertures for feeding microorganisms into the treatment bath.

12. The apparatus as claimed in claim 11, wherein the microorganism-feeding trough is connected with the water supply pipe.

13. The apparatus as claimed in claim 12, wherein the microorganism-feeding trough is adapted to feed microorganisms along with water supplied through the water supply pipe.
